(19) United States
(12) Patent Application Publication
(10) Pub. No.: US 2003/0048011 A1
(43) Pub. Date: Mar. 13, 2003

(54) Magneto-electric machine of linear type

(76) Inventors: Alexander Kashkarov, Saint Petersburg (RU); Nikolay Shkolnik, West Hartford, CT (US); Sergey Logvinov, Saint Petersburg (RU); Rudolf K. Evseev, Saint Petersburg (RU)

Correspondence Address: STANGER & DREYFUS, 608 SHERWOOD PKWY, MOUNTAINSIDE, NJ, 07092, US

(21) Appl. No.: 10/224,282

(22) Filed: Aug. 20, 2002

Related U.S. Application Data
(60) Provisional application No. 60/313,965, filed on Aug. 21, 2001.
(60) Provisional application No. 60/313,841, filed on Aug. 21, 2001.
(60) Provisional application No. 60/313,847, filed on Aug. 21, 2001.
(60) Provisional application No. 60/313,837, filed on Aug. 21, 2001.

(51) Int. Cl. H02K 41/00

(52) U.S. Cl. 310/12

(57) ABSTRACT

The invention claimed here refers to electrical engineering and may be used to convert mechanical energy of reciprocating motion to electrical energy and vice versa. The machine has a stator with windings and a moving body installed in such a way that a possibility of reciprocating motion is provided. The stator has at least one magnetic part, each of which has at least one permanent magnet and has at least three unidirectional projections that form magnetic poles of alternating polarity. The cavities are formed between the projections, with stator windings placed in said cavities. The moving body has at least one part made of magnetically soft material. The stator and the moving body are positioned so that the moving body part made of magnetically soft material, in the course of the motion of the moving is (at least partially) within the magnetic fields of the poles of the magnetic part of the stator. The invention may be used for the creation of linear electric machines characterized by high dynamic characteristics, high efficiency and low weight and size.

### RELATED APPLICATIONS

Priority is claimed to U.S. Provisional Patent Application Ser. No. 60/313,965 filed Aug. 21, 2001; U.S. Provisional Patent Application Ser. No. 60/313,841, filed Aug. 21, 2001; U.S. Provisional Patent Application Ser. No. 60/313,847, filed Aug. 21, 2001; U.S. Provisional Patent Application Ser. No. 60/313,837, filed Aug. 21, 2001.

### FIELD OF THE INVENTION

The invention claimed herein relates to electrical engineering. More particularly, the present invention relates to magneto-electric machines, and may be used in the manufacture of reciprocal-motion electric drives for various purposes, e.g. linear generators, feed drive systems, pumps, electromagnetic valves, shutters, clutches, etc.

### BACKGROUND OF THE INVENTION

Linear magneto-electric machines are known (see, for example, U.S. Pat. No. 3943390, SU 1728942, RU 2050036) that comprise one stator winding, magnetic part of a stator, with said magnetic part having two opposite magnetic poles of a stator and including one permanent magnet and magnetic conductor made of magnetically soft material, and a moving body made of magnetically soft material. Said movable body serves to change the working magnetic flux of the magnetic circuit depending on the mutual positions of stator's magnetic part and movable body. However, such devices are short-traveling devices, they have only one stable equilibrium position, and are mainly intended for operation in the mode of generator employing the modulation of unidirectional magnetic flux. Besides, the conversion of mechanical energy of movable body travel in these devices proceeds with low efficiency which fact is associated with incomplete utilization of magnetic flux and high value of leakage flux.

There are linear magneto-electric machines (see, for example, JP 07031117) that comprise: four stator windings, magnetic part of a stator, having two permanent magnets with their opposite poles being adjacent to the outer magnetic conductor, made of magnetically soft material, and with their other poles being adjacent to two inner magnetic conductors, each of which forms two magnetic poles of the same polarity, and a moving body, two parts of which are made of magnetically soft material and are located between the opposite poles of the two inner magnetic conductors. Stator windings embrace the poles of the inner magnetic conductors, and the length of each part of the moving body made of magnetically soft material is equal to the length of the pole of the magnetic part of the stator in the direction of the moving body motion. When the moving body moves, the main magnetic flux from permanent magnets does not vary in value, but is redistributed between magnetic poles of the stator. However such devices are the short-traveling devices, whose length of stroke does not exceed the size of the magnetic pole in the direction of the moving body motion, with the moving body being in indifferent equilibrium within the stator pole. This design of linear magneto-electric machines is oversized and overweighed, characterized by incomplete use of magnetic energy and low efficiency because of the presence of a permanent magnetic flux component that closes up via stator poles.

There are designs of linear magneto-electric machines (see, for example, JP 11187638) that comprise: one stator winding, a magnetic part of a stator with the said magnetic part having a stator magnetic conductor having two projections with a winding placed between them. Two permanent magnets are placed on the each of the above-mentioned projections, and said permanent magnets form two opposite magnetic poles facing the moving body made of magnetically soft material and having two projections directed to stator poles, with the size of the projection of the moving body being equal to the size of one magnetic pole of the stator in the direction of the moving body motion. However, these devices are also short-travel devices, and the length of a stroke in these devices does not exceed the size of the magnetic pole in the direction of the moving body motion, with said moving body being in one of three equilibrium positions within two stator poles. This design of linear magneto-electric machines is characterized by the great weight of the magnetic conductor of the stator, excessively high winding volume, excessive weight of permanent magnets, and low utilization factor of the energy of magnets because only half of the total number of magnets, located at different projections of the magnetic conductor of the stator, takes part in setting up the motion of the moving body in one direction.

There are linear stepping magneto-electric motors (see, for example, EP 0033803) that comprise: one stator winding; a magnetic part of the stator having magnetic conductor of the stator, with said magnetic conductor being made of magnetically soft material and having two projections with a winding placed between them; two permanent magnets installed at the ends of the magnetic conductor of the stator by the like poles; and two additional pole tips made of magnetically soft material, with the magnetic part of the stator forming four spaced apart magnetic poles directed toward to a toothed moving body made of magnetically soft material. This design of magneto-electric machines of linear type is characterized by the great weight of the magnetic conductor of the stator, excessively high winding volume, excessive weight of permanent magnets, and low utilization factor of the energy of magnets because only one of the magnets takes part in setting up the motion of the moving body at a time. Low efficiency of this magneto-electric machine is caused by high leakage flux.

There are linear magneto-electric machines (see, for example, GB 2205003, U.S. Pat. No. 5220223, EP 0450288) that comprise two stator windings a magnetic part of the stator, with said magnetic part having one permanent magnet located between the stator windings with one of its poles placed on the magnetic conductor of the stator, with said magnetic conductor embracing the stator windings and having two projections. The magnetic part of the stator forms three magnetic poles of alternating polarity that are directed toward the moving body that has two parts made of magnetically soft material and separated with a gap, with the two above-mentioned parts of the moving body being placed in the fields of the poles of the magnetic part of the stator and the above-mentioned gap being arranged under the central pole of the magnetic part of the stator, with said central pole being the pole of the permanent magnet. Operation of these electric machines is based on the principle of invariable magnetic resistance along the path of magnetic fluxes of the stator regardless of the position of the moving body, while the forces applied to the moving body result due to the redistribution of the magnetic flux along the length of the permanent magnet, with the total value of this magnetic flux being invariable. However, these devices are short-travel devices, with the length of a stroke that does not exceed the size of the central magnetic pole in the direction of travel of the moving body and with the moving body being in indifferent equilibrium with respect to the stator. High required magneto-motive force of the stator winding leads to low drops in the total magnetic flux that is equal to the sum of fluxes of the permanent magnet and the winding at one extreme pole of the magnetic part of the stator, and that is equal to the difference of fluxes generated by the permanent magnet and the windings at the other extreme pole of the magnetic part of the stator, which fact, in its turn, results in the formation of a permanent component of the magnetic flux and, hence, to inefficient utilization of the usable volume of the machine.

### SUMMARY OF THE INVENTION

The engineering problem at the solution of which the invention claimed herein is aimed consists in the development of a linear magneto-electric machine exhibiting improved energy-related parameters, as well as weight and size parameters.

The essence of the invention consists in the fact that the linear magneto-electric machine comprises a stator with windings and a moving body installed in such a way that the possibility of reciprocating motion about the stator is provided. At that the stator has at least one magnetic part, each of which includes at least one permanent magnet and has at least three unidirectional projections that form magnetic poles of the magnetic part of the stator of alternating polarity in the direction of the above-mentioned motion of the moving body; with the above-mentioned projections being separated by cavities where the said windings of the stator are placed at least partially, and the moving body has at least one part made of magnetically soft material, whereas the stator and the moving body are placed so that the said magnetic poles face the said part of the moving body, made of magnetically soft material, and in the course of the said motion of the moving body, the said part of the moving body is (at least partially) in the magnetic fields of the said poles of the magnetic part of the stator.

The fact that when the moving body moves, its part, made of magnetically soft material, is permanently (at least partially) in the magnetic fields of alternating-polarity poles of the magnetic part of the stator, and the fact that the design allows attaining a considerable increase in power of the permanent magnet of the magnetic part of the stator, enables one to obtain improved energy-related parameters of the magneto-electric machine due to better utilization of the energy of the permanent magnets, a decrease in leakage fluxes of magnetic energy, and an increase in magneto-motive force accompanied by a reduction in weight and size.

In the magneto-electric machine claimed herein, the moving body may have several parts made of magnetically soft material and placed along the direction of the moving body motion, and the size of the parts of the moving body made of magnetically soft material and measured in the direction of the moving body motion, is in the range from one to two distances between the poles of the stator. This provides a way for manufacturing multiphase magneto-electric machines of linear type offering higher energy-related parameters. The single multiphase magnetic part of the stator with windings having no non-magnetic spacers (that are generally used to separate phase parts of the stator) permits the size of the stator to be reduced in the direction of the moving body motion.

In the magneto-electric machine claimed herein, at least one part of the moving body, made of magnetically soft material, may have teeth directed to the said poles of the magnetic part of the stator. This makes it possible to increase the specific energy-related parameters of the machine, in particular, tractive force per unit of active weight of the machine or its volume. In particular, the teeth may be made with a pitch not exceeding the distance between the poles of the magnetic part of the stator, whereas the relation between linear dimensions of the stator and moving body part made of magnetically soft material, in the direction of the moving body motion is so, that the size of a tooth does not exceed that of the pole of the magnetic part, while the length of the moving body part made of magnetically soft material, is greater than, or equal to the length of the magnetic part of the stator. This permits electromagnetic reduction to be developed in the magneto-electric machine which increases tractive force and decreases the travel speed of the moving body motion at fixed values of current in machine windings due to the increase of the electromagnetic conversion factor.

To simplify the manufacture of the magneto-electric machine claimed herein, the magnetic part of the stator may be assembled of separate elements.

In particular, all the elements that when assembled form the magnetic part of the stator, may be made of permanent magnets. This results in increase of energy capacity of the machine, namely, when the machine operates in the mode of generator, the electromotive force, excited in the windings per unit of the active volume of the magneto-electric machine, increases in value, while when the machine operates in the mode of motor the tractive force per unit of the active volume of the machine increases in value.

In another particular case of the embodiment of the present invention, at least one element of those that in assembly form the said magnetic part of the stator, may be made of permanent magnet, and at least one of the said elements that in assembly form the said magnetic part of the stator, may be made of magnetically soft material. This permits full advantage to be taken of the energy of permanent magnet and manufacturing process to be simplified.

To increase induction under the pole of the magnetic part of the stator and to reduce the volume of permanent magnet with a value of tractive force being fixed in the magneto-electric machine claimed herein, at least one of the magnetic poles (made of permanent magnet) of the magnetic part of the stator may have a tip that is made of magnetically soft material and that forms a concentrator of magnetic flux in the direction to the moving body.

To increase tractive force, the magneto-electric machine may have a stator, composed of several magnetic parts. In this case these parts of the stator may be installed successively one after another in the direction perpendicular to the direction of the moving body motion.

In the magneto-electric machine claimed herein, in the case when the stator is made of several magnetic parts, these magnetic parts of the stator may be installed in a fan-shaped manner around the moving body. This permits better utilization of the active volume and reduction in the total volume of the magneto-electric machine accompanied by simultaneous decrease in tractive force pulsation in the mode of motor.

In the magneto-electric machine claimed herein, in the case when the stator is made of several magnetic parts, the said moving body may be made hollow, the said moving body part made of magnetically soft material, may be placed on the inside of the said moving body, while the magnetic parts of the stator may be placed inside the said moving body in a fan-shaped manner. This causes an increase in the total value of tractive force and simplifies manufacturing process.

To provide further increase in force developed per unit of the active volume of the machine, in the last particular case of the embodiment of the magneto-electric machine claimed herein, the said moving body may have an additional central element, at least one part of which is made of magnetically soft material, and additional magnetic parts of the stator, placed inside the said moving body in a fan-shaped manner; with the poles of the additional magnetic parts of the stator facing the said part (made of magnetically soft material) of the central element of the moving body; with the said part being, at least partially, within the magnetic fields of the said poles of the additional magnetic parts of the stator. This design provides for more efficient utilization of machine volume.

Also in the latter particular case of the embodiment of the invention, instead of the said additional central element, the magneto-electric machine claimed herein may have an additional moving body, positioned along the axis of the machine, at least one part of which is made of magnetically soft material, and additional magnetic parts of the stator located inside the said moving body in a fan-shaped manner; at that, the poles of the additional magnetic parts of the stator face the said part of the additional moving body, made of magnetically soft material, that is, at least partially, within the magnetic fields of the said poles of the additional magnetic parts of the stator. Besides the above-indicated efficient utilization of the volume of the machine, such an arrangement permits manufacturing the machines, which are characterized by the mutually inverse motion of two moving bodies, as the additional moving body is not mechanically coupled with the “main” moving body and it can make motion that is reverse to that of the “main” body; this is provided by proper switchover of stator windings.

In the magneto-electric machine claimed herein, the magnetic part of the stator, the windings and the moving body may be shaped as bodies of revolution or as fragments of bodies of revolution that have a common axis; in this case the poles of the magnetic part of the stator are directed to the said axis, and the moving body is placed in space between the said poles of the magnetic part of the stator. This leads not only to an increase in specific tractive force of the magneto-electric machine but also to simplification of its manufacture.

In the magneto-electric machine claimed herein, the magnetic part of the stator, the windings and the moving body may be shaped as bodies of revolution or as fragments of bodies of revolution that have a common axis; the moving body may be made hollow, the said moving body part made of magnetically soft material, is placed on the inside of the moving body, and the magnetic part of the stator is located inside the moving body, and the poles of the magnetic part of the stator are oriented away from the said axis. This permits a decrease in electric losses in the windings and leakage flux accompanied by a decrease in active volume of the magneto-electric machine.

In the latter particular case of the invention embodiment, the magneto-electric machine claimed herein may have the said moving body, with an additional central element, at least one part of which is made of magnetically soft material, and an additional magnetic part of the stator placed inside the said moving body, and with the additional magnetic part of the stator and its windings being shaped as bodies of revolution or fragments of bodies of revolution around the said axis, with the poles of the additional magnetic part of the stator being oriented in the direction of the said axis. This design permits more benefit to be gained from the useful volume of the machine, and the total force developed per unit of the active volume of the machine to be increased.

Also, in the latter particular case of the invention embodiment, instead of the said additional central element, the magneto-electric machine claimed herein may have an additional moving body installed along the axis of the machine, at least one part of which is made of magnetically soft material, and an additional magnetic part of the stator placed inside the said moving body; in this case the additional magnetic part of the stator and its windings are shaped as bodies of revolution or fragments of bodies of revolution around the said axis, and the poles of the additional magnetic part of the stator are oriented in the direction of the said axis. This design will result not only in more rational utilization of the usable volume of the machine and in increase of the total force developed per unit of active volume of the machine, but also in providing the possibility of manufacturing machines, ensuring mutually reverse motion of the two moving bodies.

To increase winding space and save material of permanent magnets with consideration for their odd-shaped designs, in the magneto-electric machine claimed herein, it is preferable to make the permanent magnets of the magnetic part of the stator with the approximately constant cross-sectional area along the path of magnetic flux.

To ensure reversible modes of operation—i.e. both as a motor and as a generator,—and to provide a drive with preset dynamic and energy-related parameters, a sensor of the position of the moving body may be installed in the magneto-electric machine claimed herein, with said sensor being intended for controlling the switchover of stator windings.

### BRIEF DESCRIPTION OF THE DRAWINGS

The essence of the present invention is illustrated by graphic materials showing:

FIG. 1—example of the embodiment of the single-phase magneto-electric machine (single-module version);

FIG. 2—example of the embodiment of a multiphase magneto-electric machine (multi-module version);

FIG. 3, FIG. 4—examples of the embodiment of the multiphase magneto-electric machine in which the part of the moving body made of magnetically soft material, has magneto-conducting teeth;

FIG. 5—example of the embodiment of the magneto-electric machine in which the magnetic part of the stator is assembled of permanent magnets;

FIG. 6, FIG. 7—examples of the embodiment of the multiphase magneto-electric machine in which the magnetic part of the stator consists of permanent magnets with the magnetic conductor made of magnetically soft material, has magnetic tips;

FIG. 8—example of the embodiment of the magneto-electric machine with a stator composed of several magnetic parts arranged in a direction perpendicular to the motion of the moving body;

FIG. 9—example of the embodiment of the magneto-electric machine with the magnetic parts of the stator arranged in a fan-shaped manner around the moving body;

FIG. 10—example of the embodiment of the magneto-electric machine with the outside location of the moving body with respect to the magnetic parts of the stator;

FIG. 11—example of the embodiment of the magneto-electric machine with concurrent outside and inside location of the moving body with respect to the magnetic parts of the stator;

FIG. 12, FIG. 13—examples of the embodiment of the coaxial design of the magneto-electric machine with both inside and outside location of the moving body with respect to the magnetic parts of the stator;

FIG. 14, FIG. 15—examples of then embodiment of the coaxial design of the magneto-electric machine with the concurrent outside and inside location of the moving body with respect to the magnetic parts of the stator;

FIG. 16—example of the embodiment of the magnetic part of the stator with a permanent magnet that has an equal cross-section along the main magnetic flux generated by this magnet.

### DETAILED DESCRIPTION OF THE INVENTION

FIGS. 1-16 show examples of the embodiment of the linear magneto-electric machine that can be implemented in accordance with the above-described essence of the invention. Bearing mount units and fastening components of the parts of the design are not shown in FIGS. 1-16 for the sake of simplicity.

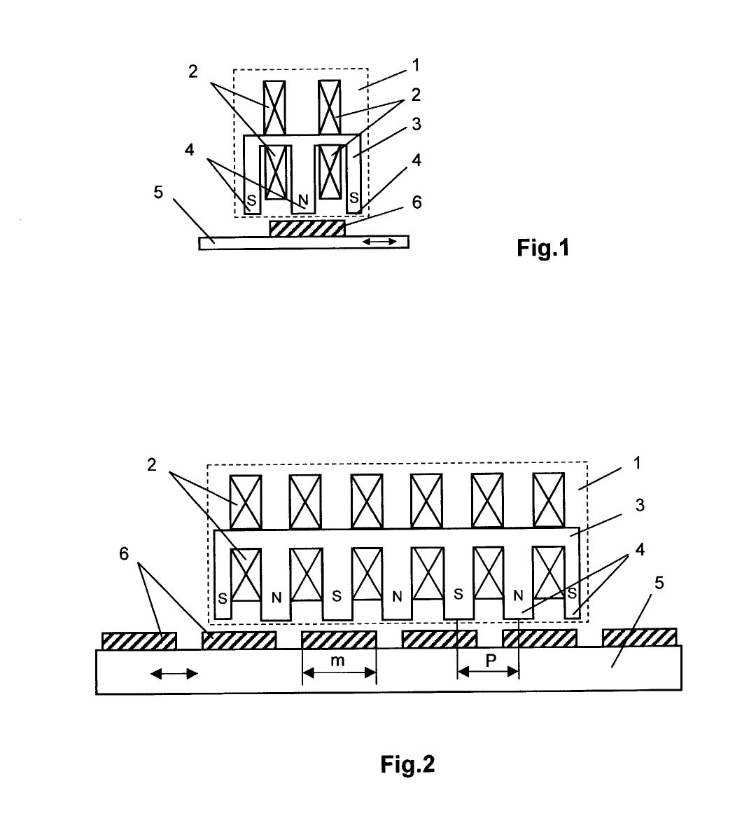

FIG. 1 exemplifies a single-phase basic design of the magneto-electric machine that includes a minimum set of constructs needed to embody the invention. The principle of operation of this design can be applied to any of the particular examples of designs shown in following FIGS. 2-16.

FIG. 1 furnishes an example of a machine that comprises stator 1, having two windings 2 and magnetic part 3 with three magnetic poles 4 of alternating polarity. Besides, the machine comprises moving body 5 part 6 of which is made of magnetically soft material. When moving body 5 moves along poles 4 of magnetic part 3 of stator 1, part 6 of moving body 5 will vary the magnetic resistance of magnetic circuits, embracing windings 2; in so doing, the magnetic flux that embraces one of windings 2, will increase, whereas the magnetic flux that embraces another winding 2 will decrease, thus exciting electromotive forces of the opposite sign in windings 2.

Moving body 5 may have several parts 6, made of magnetically soft material and arranged along the direction of the motion of moving body 5 (see FIG. 2); at that, magnetic part 3 of stator 1 may contain a number of magnetic poles 4 of alternating polarity in the direction of the motion of moving body 5, with windings 2 being located (at least partially) between magnetic poles 4. When making parts 6 of moving part 5 of size “m”, whose value ranges from one to two distances between the poles “P” of stator 1, one may create multiphase linear magneto-electric machines that would provide a great stroke of moving body 5.

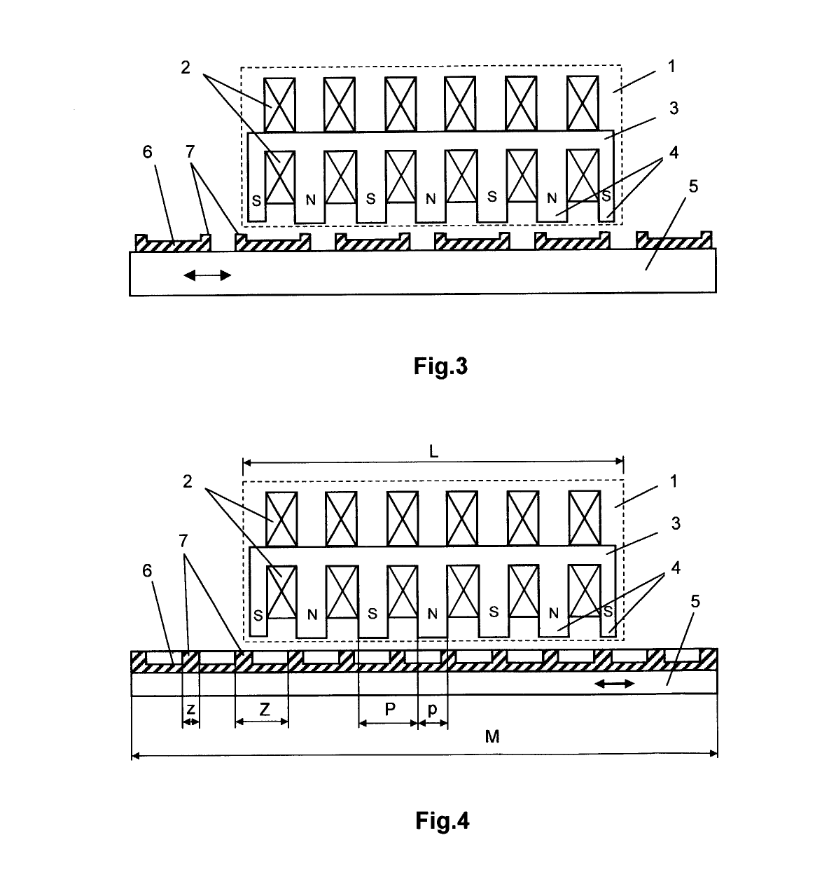

Parts 6 of moving body 5 made of magnetically soft material (see FIG. 3), may have teeth 7 arranged in the direction of the motion of body 5; they permit an increase in the rate of changes of the magnetic flux and, hence, the electromotive force of the windings (when the machine operates in the mode of generator) and tractive force (when the machine operates in the mode of motor). In particular, in the case of multiphase embodiment of the magneto-electric machine (see FIG. 4), part 6 of moving body 5 may have teeth 7 arranged with pitch “Z” not exceeding the distance between the poles “P” , and the relationship of linear dimensions of magnetic part 3 of stator 1 and part 6 of moving body 5 in the direction of its motion is so that dimension “z” of tooth 7 does not exceed dimension “p” of pole 4 of magnetic part 3, and length “M” of part 6 made of magnetically soft material, of moving body 5 is greater than, or equal to length “L” of magnetic part 3 of stator 1. Such an embodiment of moving body 5 not only simplifies the design, but also permits the development of electromagnetic reduction in the magneto-electric machine that increases tractive force and decreases the speed of moving body 5 with a fixed value of current in windings 2 of the machine due to an increase in electromagnetic conversion factor.

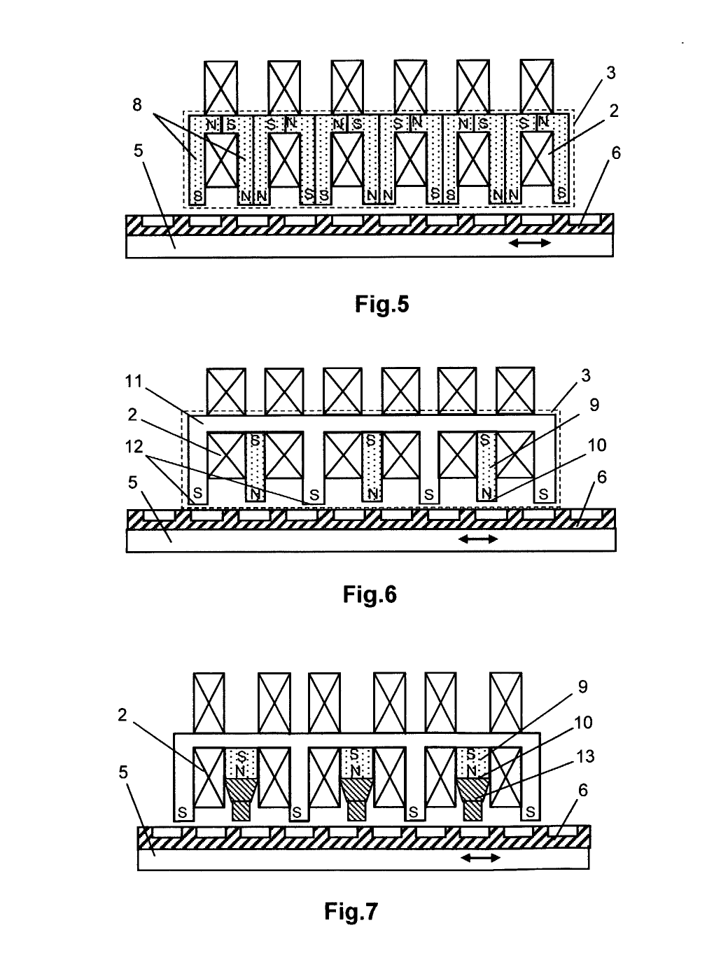

To simplify the manufacturing process, magnetic part 3 of stator 1 may be assembled of separate elements (see FIG. 5). For example, all the elements that in assembly form magnetic part 3 of stator 1, may be made of permanent magnets 8. This results in increase of energy capacity of the machine, namely, electromotive force excited in windings 2, increases in value per unit of the active volume of the machine when operated in the mode of generator, and tractive force per unit of active volume increases in value for the operation in the mode of motor. To take full advantage of the energy of permanent magnet and to simplify the manufacturing process, in the magneto-electric machine (see FIG. 6) claimed herein, one of the elements that in assembly form magnetic part 3 of stator 1, may be made of permanent magnet 9, for example, forming pole 10, whereas another element 11 that forms poles 12-of magnetically soft material.

To increase induction and decrease permanent magnet volume at a fixed value of tractive force (see FIG. 7), poles 10, formed by permanent magnet 9, may have tips 13 made of magnetically soft material, that form concentrators of magnetic flux in the direction toward moving body 5.

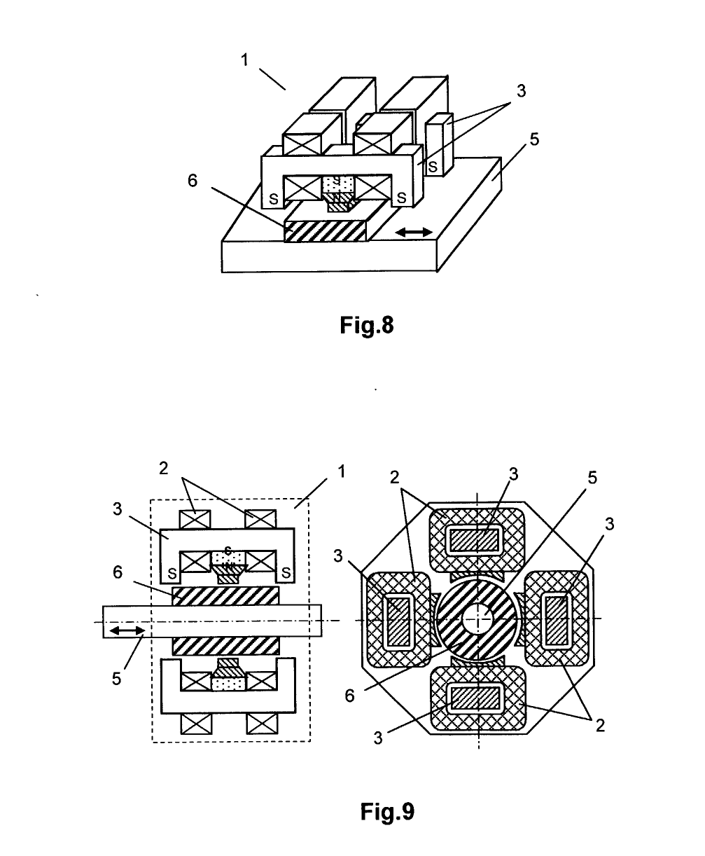

To increase tractive force, the machine (see FIG. 8) may have stator 1 made of several magnetic parts 3. These magnetic parts 3 of stator 1 are arranged successively one after another perpendicular to the direction of the motion of moving body 5.

When stator 1 is made of several magnetic parts 3, the latter may be arranged in a fan-shaped manner around moving body 5 (see FIG. 9) or inside the hollow moving body 5(see FIG. 10). This ensures better utilization of the active volume and decrease in the total volume of the magneto-electric machine, accompanied by simultaneous decrease in tractive force pulsation.

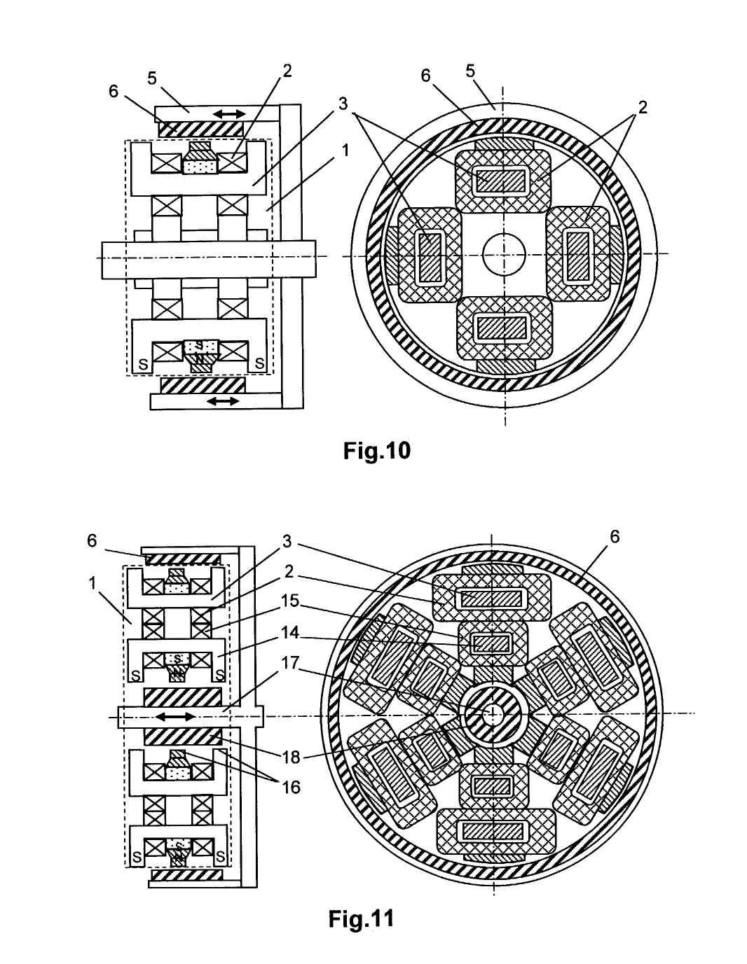

A further increase in force developed per unit of active volume of magneto-electric machine may be exemplified by a design, shown in FIG. 11, that combines the possibilities of designs shown in FIG. 9 and FIG. 10. The machine shown in FIG. 11 has stator 1 made of magnetic part 3 and additional magnetic part 14 with windings 15 and poles 16. Moving body 5 is made hollow with stator 1 placed inside it. In addition, moving body 5 has central element 17 with part 18 made of magnetically soft material, whereas magnetic part 14 is positioned so that its poles 16 face part 18 (made of magnetically soft material) of central element 17. This embodiment permits efficient utilization of the volume of the machine. Moreover, if central element 17 is made as a separate element, not coupled mechanically with moving body 5 (not shown in FIG. 11), then proper switchover of windings 2 and windings 15 of magnetic parts 3 and 4 of stator 1 can ensure mutually reverse motion of the two moving bodies.

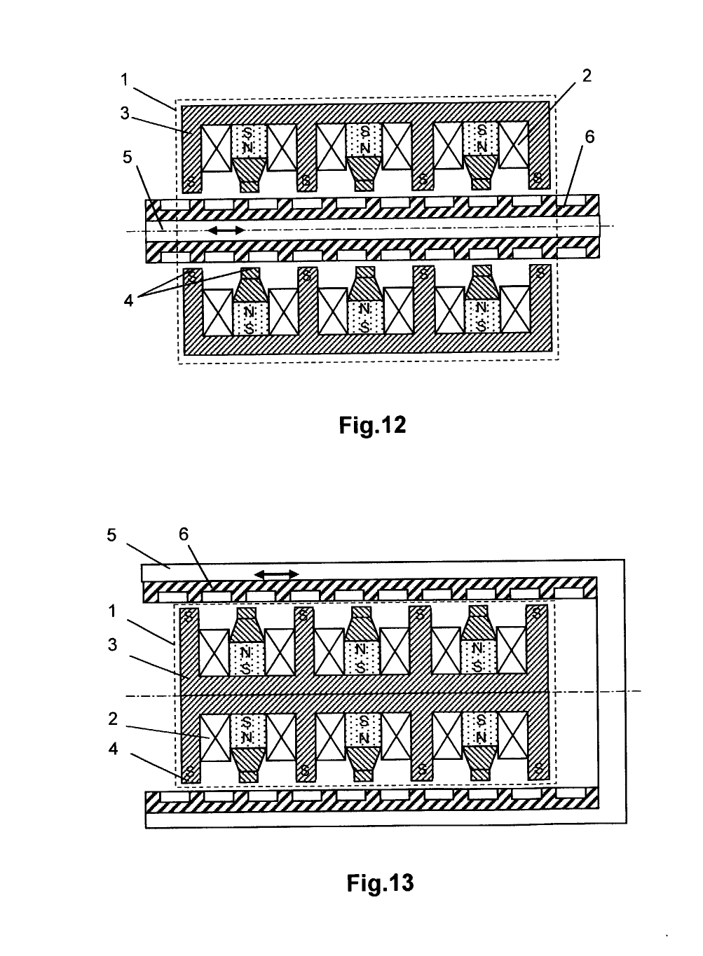

To reduce losses in the windings and to increase the specific tractive force of the magneto-electric machine (see FIG. 12), magnetic part 3 of stator 1, windings 2, and moving body 5 may be made as bodies of revolution or fragments of bodies of revolution that have a common axis; in this case poles 4 of magnetic part 3 of stator 1 are directed toward the said axis, whereas moving body 5 is located in the space between poles 4 of magnetic part 3 of stator 1.

It is possible to manufacture the magneto-electric machine (see FIG. 13) in which magnetic part 3 of stator 1, windings 2 and moving body 5 are made as bodies of revolution or fragments of bodies of revolution that have a common axis; in this case, moving body 5 is made hollow, part 6 of moving body 5 made of magnetically soft material, is located on the inside of moving body 5, whereas magnetic part 3 of stator 1 is located inside moving body 5, and poles 4 of magnetic part 3 of stator are oriented away from the said axis.

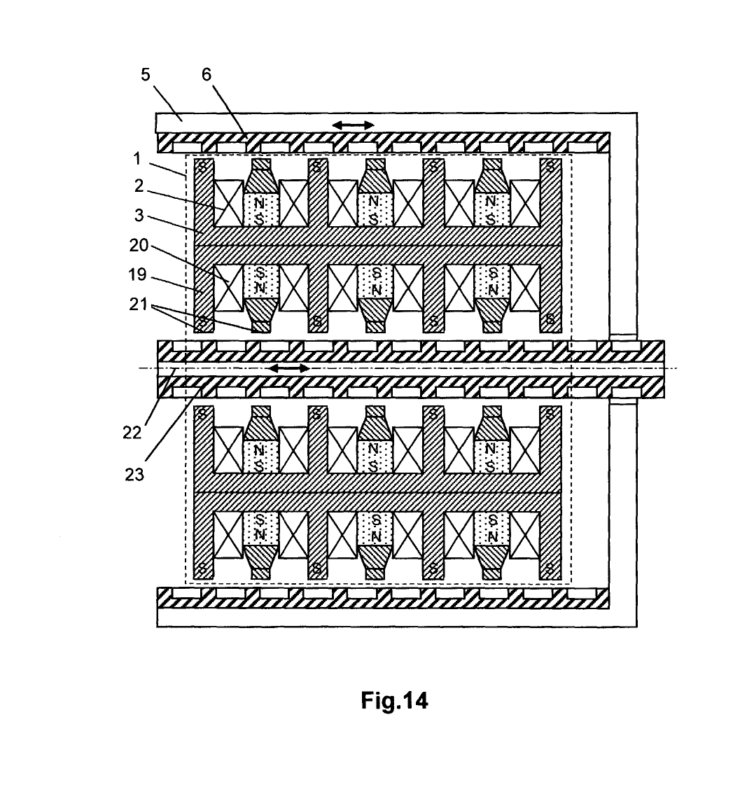

Design, shown in FIG. 14, is a combination of designs of the magneto-electric machines, shown in FIG. 12 and FIG. 13; it has stator 1, composed of magnetic part 3 and additional magnetic part 19 with windings 20 and poles 21. Moving body 5 is made hollow with stator 1 placed inside it. Additional moving body 22, part 23 of which is made of magnetically soft material, is arranged along the axis of the machine. Moving body 22 is controlled by windings 20 of additional magnetic part 19; it can perform counter-phase motion with respect to moving part 5. As an alternative, moving body 22 may be mechanically coupled with moving part 5 (for example, as shown in FIG. 11). In this case, the switchover of windings 2 and 22 should ensure in-phase motion of this combined moving part 5.

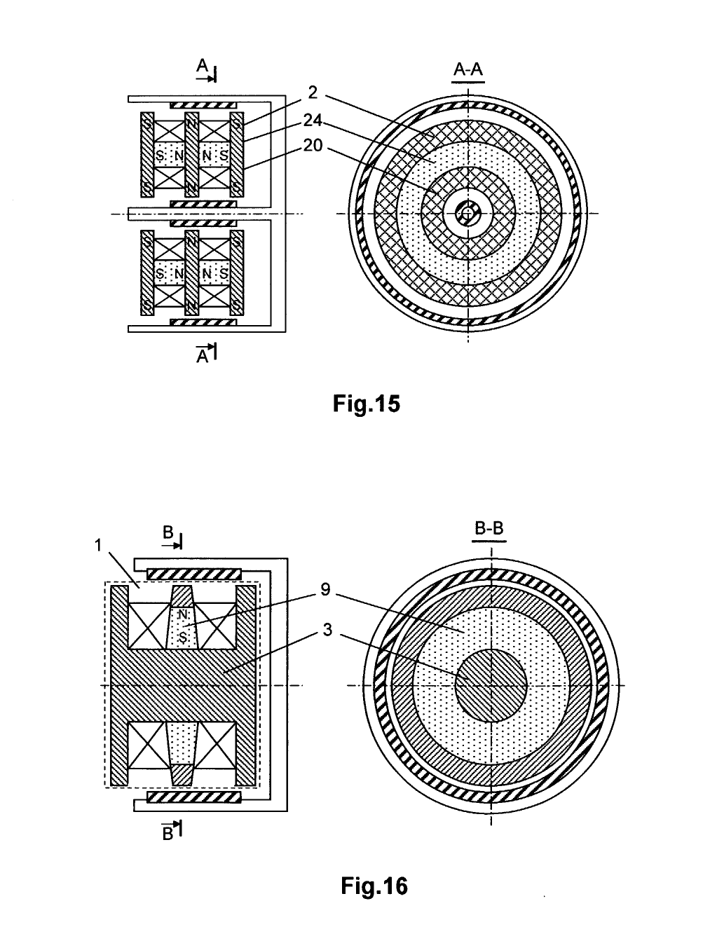

FIG. 15. shows a similar design of the machine where the permanent annular magnets 24 with axial magnetization are used in the design of magnetic parts. To increase winding space and save material of permanent magnets with consideration for their odd shapes, for example, annular shape with radial magnetization, in the magneto-electric machine, shown in FIG. 16, permanent magnets 9 of magnetic part 3 of stator 1 may be made with approximately constant cross-sectional area along magnetic flux path.

In spite of multiple versions of its embodiment (FIG. 1-FIG. 16), the magneto-electric machine claimed herein consists of small number of similar-type parts (FIG. 1). To ensure further unification of the parts, increase in tractive force and power, the design effort may follow the path of linear buildup of separate modules both along the motion of the moving body and across the motion of the moving body.

The use of parts, made as bodies of revolution (FIG. 12-FIG. 16), further simplifies the process of manufacture of electric machines of this class and, in addition, permits essential decrease in specific consumption of material not at a sacrifice of high energy-related indicators.

The above-indicated properties permit the present magneto-electric machine to operate two modes-namely, in the mode of motor and mode of generator.

1. A magneto-electric machine of linear type that comprises a stator with windings and a moving body installed so that to provide a possibility of reciprocating motion with respect to the stator; at that
the stator has at least one magnetic part, each of which includes at least one permanent magnet and has at least three unidirectional projections that form magnetic poles of the magnetic part of the stator of alternating polarity in the direction of the said motion of the moving body; the said projections are separated by cavities in which the said windings of the stator are placed at least partially, and
the moving body has at least one part made of magnetically soft material,
whereas the stator and the moving body are placed so that the said magnetic poles face the said moving body part that is made of magnetically soft material and that in the course of the said motion of the moving body is at least partially within the magnetic fields of the said poles of the magnetic part of the stator.

2. The magneto-electric machine of claim 1, wherein the moving body has several parts made of magnetically soft material and arranged along the direction of the motion of the moving body, and the size of the parts of the moving body that are made of magnetically soft material and that are measured in the direction of the motion of the moving body, lies in the range from one to two distances between the poles of the stator.

3. The magneto-electric machine of claim 1, wherein at least one part of the moving body made of magnetically soft material has teeth that face the said poles of the magnetic part of the stator.

4. The magneto-electric machine of claim 3, wherein the said teeth are made with a pitch not exceeding the distance between the poles of the magnetic part of the stator, and the relationship of linear dimensions of the stator and the moving body part made of magnetically soft material, in the direction of the motion of the moving body is so that the size of a tooth does not exceed that of the pole of the magnetic part, whereas the length of the moving body part made of magnetically soft material, is greater than, or equal to the length of the magnetic part of the stator.

5. The magneto-electric machine of claim 1, wherein the magnetic part of the stator is made assembled of separate elements.

6. The magneto-electric machine of claim 5, wherein all said elements assembled to form the said magnetic part of the stator, are made of permanent magnets.

7. The magneto-electric machine of claim 5, wherein at least one of the elements that form, when assembled, the said magnetic part of the stator is made of permanent magnet, and at least one of the said elements that form, when assembled, the said magnetic part of the stator is made of magnetically soft material.

8. The magneto-electric machine of claims 6, 7, wherein at least one of magnetic poles of the stator magnetic part, made of permanent magnet, has a tip made of magnetically soft material, that forms a concentrator of magnetic flux.

9. The magneto-electric machine of claim 1, wherein in the case of making the stator assembled of several magnetic parts, the said magnetic parts of the stator are arranged successively one after another at a direction perpendicular to the direction of the motion of the moving body.

10. The magneto-electric machine of claim 1, wherein in the case of making the stator assembled of several magnetic parts, the said magnetic parts of the stator are arranged in a fan-shaped manner around the moving body.

11. The magneto-electric machine of claim 1, wherein in the case of making the stator assembled of several magnetic parts, the said moving body is made hollow, the said part of the moving body made of magnetically soft material, is placed on the inside of the moving body, whereas the magnetic parts of the stator are located inside the said moving body in a fan-shaped manner.

12. The magneto-electric machine of claim 11, wherein the said moving body has, as an addition, a central element, at least one part of which is made of magnetically soft material, and additional magnetic parts of the stator arranged inside the said moving body in a fan-shaped manner, with the poles of the additional magnetic parts of the stator facing the said part of the central element of the moving body; with the said part being made of magnetically soft material and being located (at least partially) in the magnetic fields of the said poles of the additional magnetic parts of the stator.

13. The magneto-electric machine of claim 11, wherein it has an additional moving body installed along the axis of the machine, at least one part of which is made of magnetically soft material, and additional magnetic parts of the stator arranged inside the said moving body in a fan-shaped manner, whereas the poles of the additional magnetic parts of the stator face the said part of the additional moving body, with the said part being made of magnetically soft material and being located (at least partially) in the magnetic fields of the said poles of the additional magnetic parts of the stator.

14. The magneto-electric machine of claim 1, wherein the magnetic part of the stator, the windings, and the moving body are made as bodies of revolution or fragments of bodies of revolution that have a common axis, and the poles of the magnetic part of the stator face the said axis, whereas the moving body is located in space between the said poles of the magnetic part of the stator.

15. The magneto-electric machine of claim 1, wherein the magnetic part of the stator, the windings, and the moving body are made as bodies of revolution or fragments of bodies of revolution that have a common axis; the moving body is made hollow, and the said moving body part, made of magnetically soft material is located on the inside of the moving body, whereas the magnetic part of the stator is located inside the moving body, and the poles of the magnetic part of the stator are oriented away from the said axis.

16. The magneto-electric machine of claim 15, wherein the said moving body has, as an addition, a central element at least one part of which is made of magnetically soft material, and an additional magnetic part of the stator placed inside the said moving body, with the additional magnetic part of the stator and its windings being made as bodies of revolution or as fragments of bodies of revolution around the said axis, whereas the poles of the additional magnetic part of the stator are oriented in the direction of the said axis.

17. The magneto-electric machine of claim 15, wherein it has an additional moving body installed along the axis of the machine, at least one part of which is made of magnetically soft material, and an additional magnetic part of the stator located inside the said moving body; with the additional magnetic part of the stator and its windings being made as bodies of revolution or fragments of bodies of revolution around the said axis, whereas the poles of the additional magnetic part of the stator are oriented toward the said axis.

18. The magneto-electric machine of claim 1, wherein the permanent magnets of the magnetic part of the stator have approximately constant cross-sectional area along magnetic flux path.

19. The magneto-electric machine of claim 1, wherein it has a sensor of the position of the moving body, with said sensor being intended for controlling the switching-over of stator windings.
